(19) United States
(12) Patent Application Publication
(10) Pub. No.: US 2005/0151854 A1
(43) Pub. Date: Jul. 14, 2005

(54) Image recording apparatus adding meta-information to image data

(76) Inventor: Takashi Maki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/035,200

(22) Filed: Jan. 14, 2005

(30) Foreign Application Priority Data
Jan. 14, 2004 (JP) 2004-006847

(51) Int. Cl. H04N 5/225

(52) U.S. Cl. 348/222.1; 348/207.1

(57) ABSTRACT

An image-recording apparatus includes an image-capturing unit configured to convert an optical image to image data, and a reading device configured to read meta-information from an external source. A processing unit is also included and configured to control the reading device and to associate the meta-information with the image data.

### BACKGROUND OF THE INVENTION

1. Field of the Invention

The present invention relates to an image recording apparatus, its controlling method and computer program of the method suitable for adding meta-information, such as textual information, to image data easily and quickly.

2. Discussion of the Background

An image-recording apparatus, such as a film camera, able to expose a photographing date and time onto film is known. Recently, an image-recording apparatus, such as a digital still camera, is also able to add simple text to image data other than date and time is provided. Two types of the image-recording apparatuses are provided: one adds a fixed phrase prepared in advance, and the other adds text inputted by a user with an inputting device on the camera. Japanese Patent Laid Open No. 2003-224750 describes the latter type of an image-recording apparatus having a touch panel for inputting meta-information, such as textual information.

### SUMMARY OF THE INVENTION

In an image-recording apparatus like that described above, a user must specify and enter characters one by one for inputting textual information. Therefore, the more amount or complexity of input data, the more time it takes for inputting meta-information, such as textual information. And it's hard to reduce time or trouble to input meta-information.

In view of the foregoing, it is an object of the present invention to provide an image-recording apparatus, its method and computer program of the method that can add metadata, such as textual information, to image data easily and quickly.

These and/or objects of the invention may be provided by an image-recording apparatus including an image-capturing unit configured to convert an optical image to image data, and a reading device configured to read meta-information from an external source. A processing unit is configured to control the reading device and to associate the meta-information with the image data.

In addition to the novel image-recording apparatus just described, this patent specification may be implemented in many other specific forms, including as an apparatus, method, computer program, as will be apparent to those skilled in the relevant art(s), without departing from the spirit or scope of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a rear view of the digital camera depicted in FIG. 1A;

FIG. 1B is a front view of the digital camera depicted in FIG. 1A;

FIG. 1C is a top view of a digital camera relating to an embodiment of the present invention;

FIG. 1D is a right view of the digital camera depicted in FIG. 1A;

FIG. 2 is an explanatory diagram to describe an inner constitution of a periphery of a shutter release button of the digital camera depicted in FIG. 1A;

FIGS. 3A and 3B show a block diagram showing an outline of the inner constitution of the digital still camera depicted in FIG. 1A;

FIG. 4 is a schematic diagram showing a textual information entry screen displayed on a display device, which is set on the rear surface of the digital still camera depicted in FIG. 1B;

FIG. 5A is a block diagram of a barcode reader attached into a slot of the digital camera depicted in FIG. 1D;

FIG. 5B is an outside view of the barcode reader depicted in FIG. 5A;

FIG. 6 is an explanatory diagram showing a procedure of reading textual information by the barcode reader shown in FIG. 5A; and

FIG. 7 is an explanatory diagram showing barcodes having textual information printed on a sheet.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology selected and it is to be understood that each specific element includes all equivalents that operate in a similar manner.

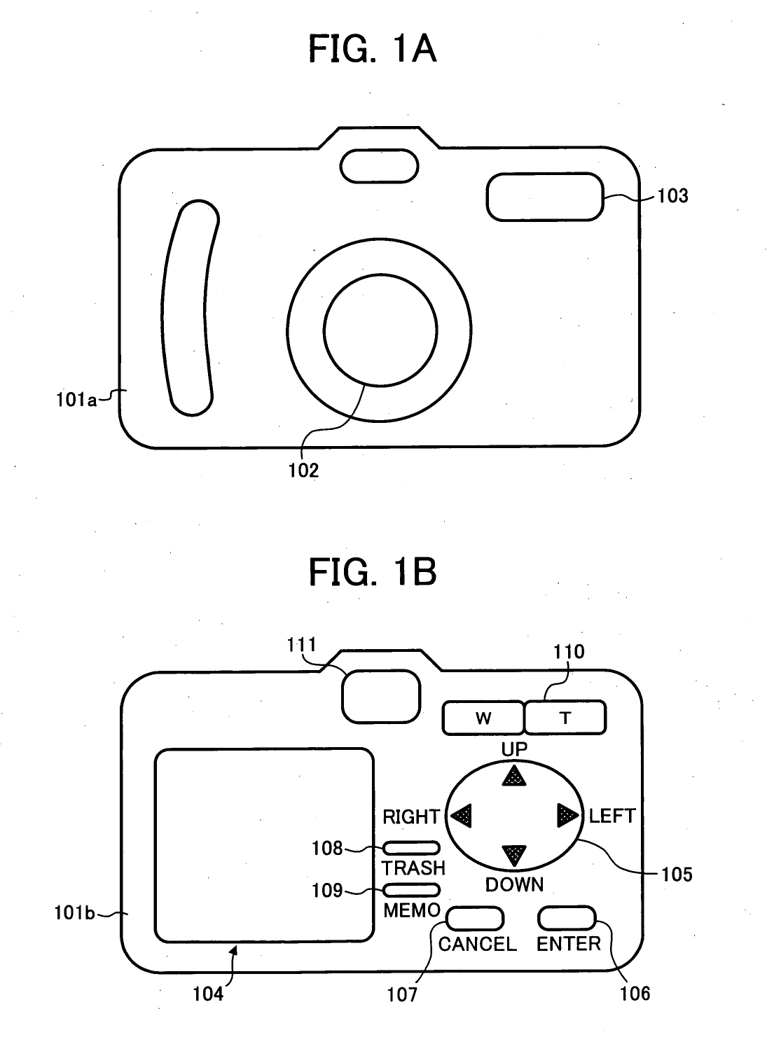

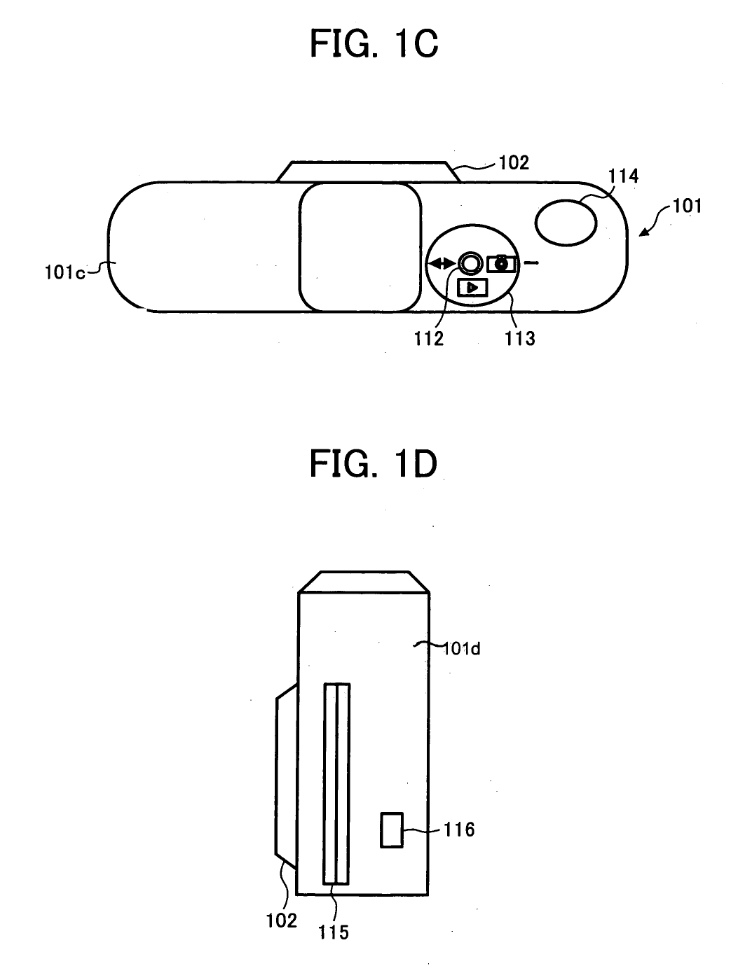

An outside view of a digital still camera 101 as an image-recording apparatus relating to one embodiment of the present invention is shown in FIG. 1A-1D. At a front surface 101a of the digital still camera 101, there is provided a photographing lens 102 and a flash lamp 103.

At back surface 101b of the digital camera 101, there is provided a display device 104, an operating button 105, and an ENTER button 106, a CANCEL button 107, a TRASH button 108, a MEMO button 109, a zooming button 110 and a viewfinder 111. According to one embodiment, the display device 104 is composed of a liquid crystal display, an electro luminescence display, a field emitting display or the like, and displays a subject when photographing or playing a photographed image. The operating button 105 carries out various operations such as a photographing condition setting, photographing mode changing or selecting of played image or the like.

Other than a mode for carrying out normal photographing, the digital camera 101 has various photographing modes such as a self-timer mode in which the photographing is carried out after a certain time has passed after pressing a shutter release button, a close photographing mode for photographing up close to the subject, a remote control photographing mode for carrying out the photographing by receiving a photographing signal from the remote control device, or an interval photographical mode for carrying out the photographing repeatedly in every predetermined time interval after the shutter release button is pressed. The changing of those photographing modes can be carried out by operation of the operating button 105.

The ENTER button 106 and the CANCEL button 107 are buttons for confirming and canceling the various operations selectable by the operating button 105, and the zooming button 110 is a button for carrying out a zooming operation of a photographing image of the subject. The viewfinder 111 is an observation window for viewing the subject when photographing, and transmitting the image of the subject from the front surface 101a.

There is provided on an upper surface 101c of the digital camera 101 a power button 112, a switching over dial 113, and a shutter release button 114. The power button 112 is a button for carrying out an on-off operation of a main power provided in a body of the digital camera 101, and the switching dial 113 is for switching between operating modes. It is possible to switch the operating mode of the digital camera 101 to the photographing mode for the photographing a subject, or to a playing mode for playing and displaying the photographed image on the display device 104.

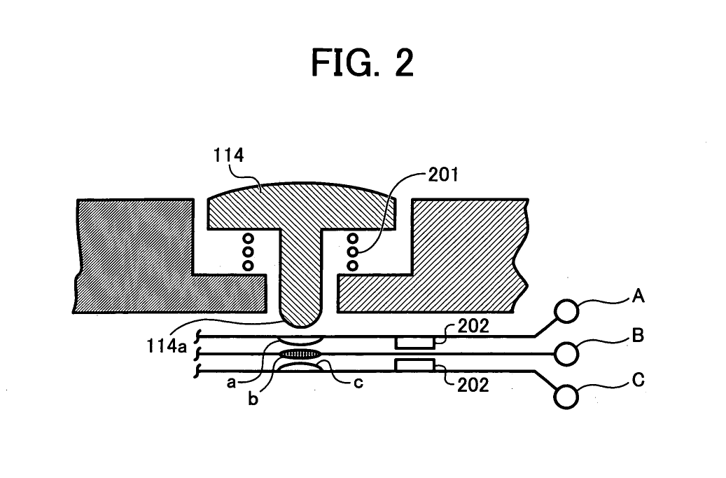

The shutter release button 114 is retained and biased upwardly by a spring 201 as shown in FIG. 2. Signal lines A-C are arranged in order in such a manner as to overlap above and below at a lower part of a lower end portion 114a of the shutter release button 114, and contact points a-c are respectively provided directly under the lower end portion 114a. The signal lines A-C are retained so as to provide a certain space by spacers 202 to prevent the contact points a-c from contacting each other when the shutter release button 114 is not pressed.

The signal lines A and B have flexibility. When the shutter release button 114 is partially pressed downward, the contact points a and b are contacted in a half-pressed condition by flexing of the signal line A pressed by the lower end portion 114a of the shutter release button 114. The contact points b and c are contacted in a full-pressed condition by the flexing of the signal line B by further pressing of the shutter release button 114.

The contact points a and b constitute a part of an inputting device for inputting a focusing starting trigger (means for inputting a focusing starting trigger), and the contact points b and c constitute a part of an inputting device for inputting a photographing starting trigger (means for inputting a photographing starting trigger). That is to say, the focusing starting trigger is inputted by a short circuit of the signal lines A and B when the contact points a and b are contacted, and the photographing starting trigger is inputted by the short circuit of the signal lines B and C when the contact points b and c are contacted.

At side surface 101d of the digital camera 101, there is provided slots 115 to insert a memory card 323 or a functional card such as a bar code reader as will be described below. A jack 116 may be used to connect a cable to communicate with an external device.

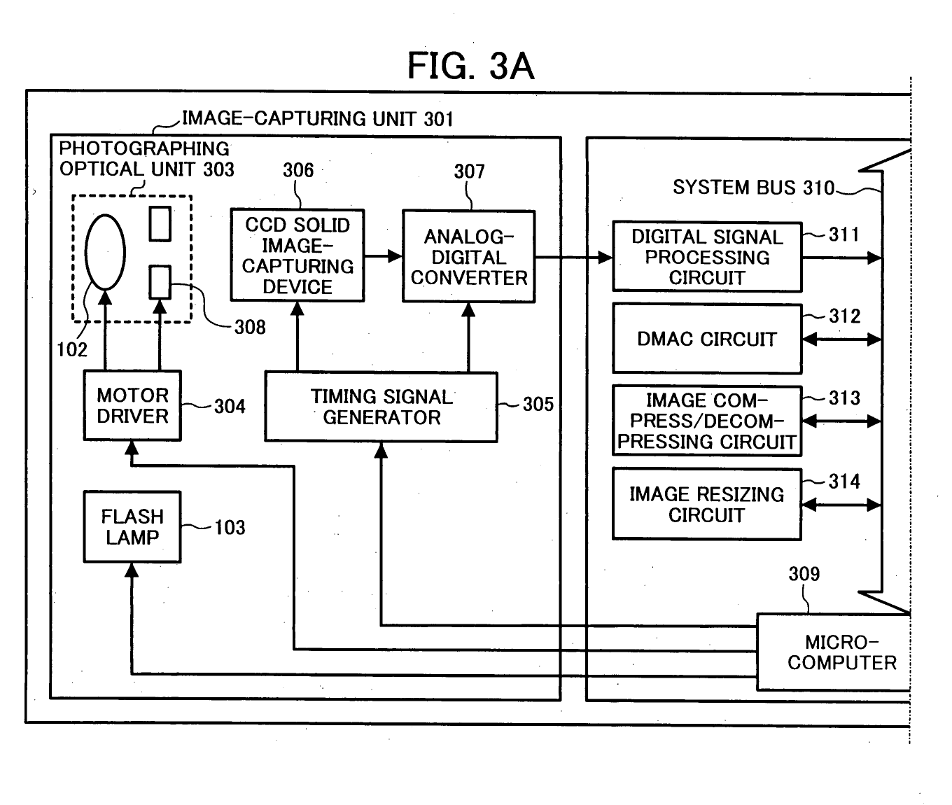

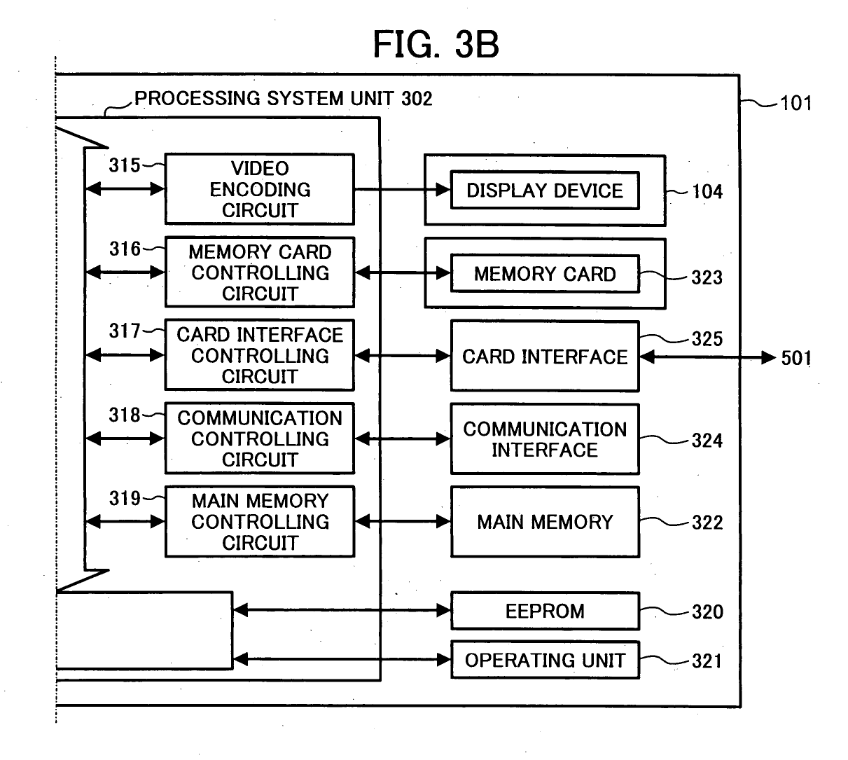

FIGS. 3A and 3B show a block diagram of a digital still camera according to one embodiment of the present invention. The digital still camera 101 has an image-capturing unit 301 and a processing system unit 302. The processing system unit 302 processes image data and controls the actions of the digital still camera 101. The image-capturing unit 301 has a photographing optical unit 303, the flash lamp 103, a motor driver 304, a timing signal generator 305, a CCD solid image-capturing device 306 and an analog-digital converter 307. The photographing optical unit 303 includes the photographing lens 102 and a shutter 308. As would be understood by one of ordinary skill in the art, a CMOS solid image-capturing device or other known devices can be used as a image-capturing device instead of a CCD solid image-capturing device.

The processing system unit 302 has a microcomputer 309, a system bus 310, a digital signal processing circuit 311, DMAC (direct memory access control) circuit 312, an image compress/decompressing circuit 313, a image resizing circuit 314, a VIDEO encoding circuit 315, a memory card controlling circuit 316, a card interface controlling circuit 317, a communication controlling circuit 318 and a main memory controlling circuit 319.

In the embodiment of FIGS. 3A and 3B, the microcomputer 309 controls the flash lamp 103, the motor driver 305 and the timing signal generator 306. The motor driver 305 moves the photographing lens 102 for zooming and focusing, and the shutter 304 for controlling incoming light. The photographing lens 102 focuses an optical image of a photographed subject onto the CCD solid image-capturing device 307, and the CCD solid-capturing device 307 converts the optical image to electric signals. The analog-digital converter 308 converts the electric signals to raw digital image data and input the image data into the digital signal processing circuit 311.

The digital signal processing circuit 311 generates RGB-formatted or YUV-formatted image data based on raw image data. The formatted image data is sent to the DMAC circuit 312, the image compress/decompressing circuit 313, the image resizing circuit 314, the VIDEO encoding circuit 315, the memory card controlling circuit 316, the card interface controlling circuit 317, the communication controlling circuit 318 and/or the memory card controlling circuit 319 through the system bus 310 under the control of the microcomputer 309.

The microcomputer 309 is connected to an EEPROM (Electrically Erasable Programmable Read-Only Memory) 320 and an operating unit 321. The EEPROM stores programs used by the microcomputer 309 to control the action of the digital still camera 101. The operating unit 321 can be composed by the operating button 105, and the ENTER button 106, the CANCEL button 107, the TRASH button 108, the MEMO button 109, the zooming button 110.

The VIDEO encoding circuit 315 converts an image data to video signals suitable to display on the display device 104. The image compress/decompressing circuit 313 compresses and decompresses image data using a lossless compression method, such as the method used in GIF (Graphics Interchange Format) format, or a lossy compression method, such as the method used in JPEG (Joint Photographic Experts Group) format. Image compression saves memory space, but is not necessary to the present invention. The DMAC circuit 312 transmits image data directly between the main memory controlling circuit 319 and the other circuits without the microcomputer 309, for load reduction of the microcomputer 309.

The main memory controlling circuit 319 stores and returns image data to and from a main memory 322. A semiconductor memory such as SDRAM (synchronous dynamic random access memory) can be used as the main memory 322. The main memory 322 can store RGB-formatted image data, YUV-formatted image data and compressed image data.

The digital still camera 101 usually records image data into a memory card 323 through the card memory controlling circuit 316. The memory card 323 is an IC memory type memory with built-in semiconductor nonvolatile memory such as a flash-memory, called as a small card. The digital still camera 101 uses the memory card 323 as a detachable external memory. The memory card 323 is removably attached into one of the slots 115 of the digital camera.

The digital still camera 101 can also transmit image data to an external device, such as a personal computer, through a communication interface 324. In one embodiment, the digital still camera 101 uses a high-speed serial interface as the communication interface 324, such as USB (universal serial bus) or IEEE (Institute of Electrical and Electronic Engineers) 1394. Image data is sent to an external device through a cable jacked into the jack 116.

The digital still camera 101 can also transmit image data through a card interface 325. For instance, a communication card, such as a wireless LAN card, a cell phone communication card or a PHS (personal handyphone system) communication card can be used to transmit image data. The communication card is removably inserted into one of the slots 115.

In the embodiment of FIGS. 3A and 3B, the card interface 325 is implemented in compliance with PCMCIA (Personal Computer Memory Card International Association) standard, CFA (CompactFlash, registered trademark, Association) standard or SD (trademark) card standard. Therefore, a card in compliance with each standard can be attached to the card interface 325. A metadata or meta-information reading device 501, described below, can be also attached to the card interface 325 as a connection port.

In this embodiment, the digital still camera 101 has the memory card controlling circuit 316 and the card interface controlling circuit 317 independently. Each standard described above can adopt to both the memory card controlling circuit 316 and the card interface controlling circuit 317. Therefore, the memory card controlling circuit 316 and the card interface controlling circuit 317 can comply with the same standard. In such case, the digital still camera doesn't need plural slots for connecting a memory card or a metadata information entry device, but may have just one common slot. This can make the digital still camera 101 more compact.

On the other hand, the memory card controlling circuit 316 and the card interface controlling circuit 317 can comply with different standards. In this case, the digital still camera 101 can use different cards. This gives the digital still camera 101 more flexibility and functional capability. For example, the card interface controlling circuit 317 and the card interface controlling circuit 317 can comply with SD standard and CFA standard respectively. In this case, the digital still camera can use a memory card having a large capacity, such as Microdrive (trademark), and a barcode reader coincidentally.

For the digital still camera 101, there are a two mode to input metadata information. One is a mode of inputting metadata by monitoring of the display device 104. The other is a mode of inputting metadata information with the metadata reading device. As used herein, the term metadata or meta-information is defined as data that provides information about image data, such as image data obtained by still camera 101. Metadata may include textual data, pictoral data such as icons, symbolic data or any other data that provides information about the image data. Thus, while the present invention is described with respect to textual information, other types of metadata may be used in accordance with the present invention.

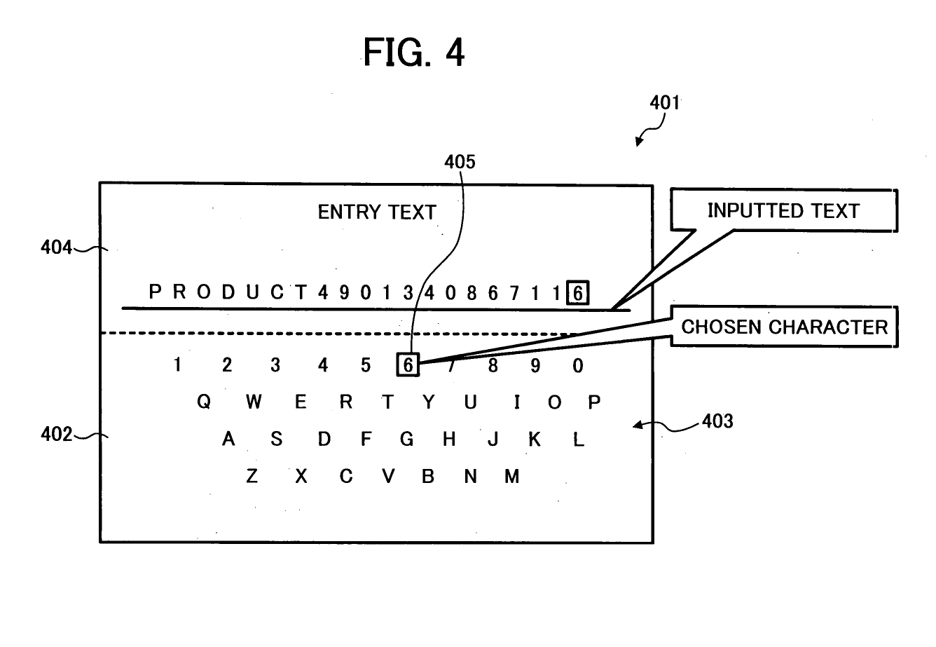

A first mode of inputting textual information with monitoring of the display device 104 is now explained. A user chooses the mode of inputting textual information with monitoring of the display device 104 by pushing the MEMO button 109. In this mode, the display device 104 displays a textural information entry screen 401, as shown in FIG. 4. A lower part of the screen 402 displays a virtual keyboard 403, while an upper part of the screen 404 displays inputted textural information. A key-layout of the virtual keyboard 403 is similar to a keyboard of personal computer available in a market.

A user operates the operating button 105 to move a cursor 405 onto a character in the virtual keyboard 403 which the user wants to input, while the user is looking at the lower part of screen 402 to check where the cursor 404 is. For instance, if a user wants to input the character “P”, the user operates the operating button 105 to move the cursor 404 onto the position of “P” in the virtual keyboard 403 and pushes the ENTER button 106 to enter “P”. Then, the display device 104 indicates “P” in the upper part of screen 404.

FIG. 4 shows the textual information entry screen 401 when the text “PRODUCT490134086771” is already entered and the character “6” is been choosing for entering it. At this time, if the user pushes the ENTER button, the display device indicates the character “6” next to the character “1” in the upper area of screen 404. When the user pushes the TRASH button 108, the character already entered and indicated in the upper area of screen 404 is deleted.

The second mode of inputting textual information with the textual information reading device is now explained. As noted in the Summary of the Invention section above, the more characters a user inputs, the more time it takes with the input method described above, because the user must operate the operating button 105 and the ENTER button 106 character by character. Therefore, the digital still camera 101 has another input method using the textual information reading device. According to one embodiment, a barcode reader 501, or a barcode scanner, is used for reading textual information. The barcode reader 501 is compliant with PCMCIA standard, CFA standard or SD card standard, for example.

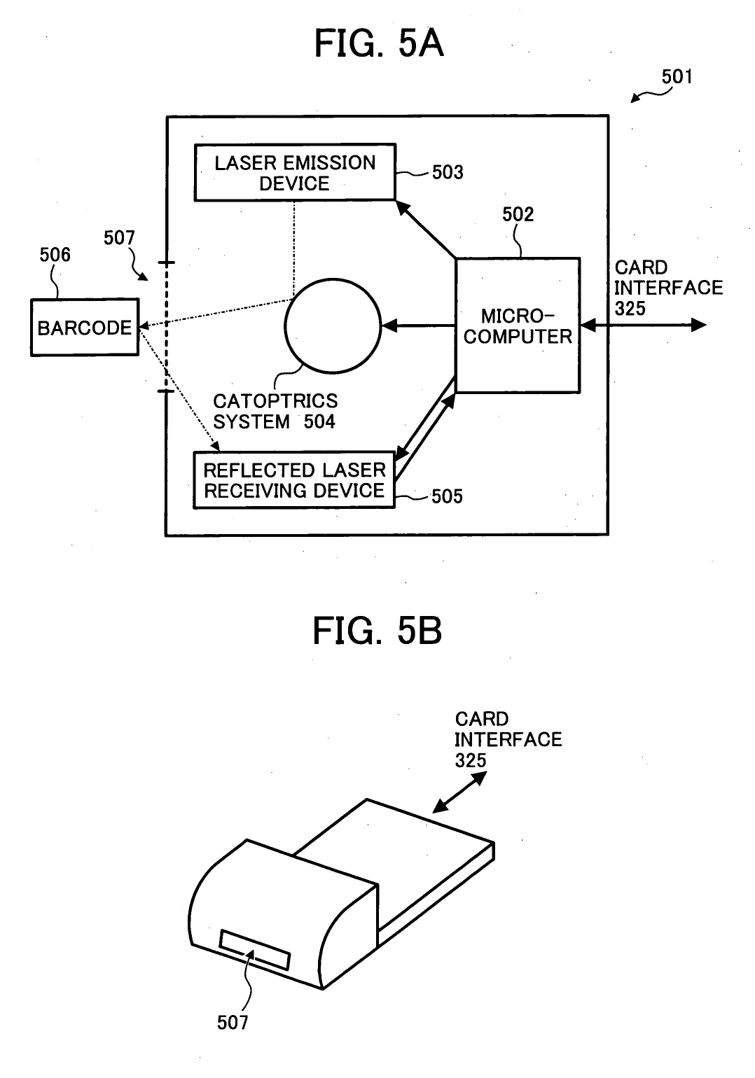

FIGS. 5A and 5B show a block diagram and an outside view of the barcode reader 501 respectively. The barcode reader 501 has a microcomputer 502, a laser emission device 503, a catoptrics system 504 and a reflected-laser receiving device 505. The barcode reader is inserted in the slot 115 and connected to the processing system unit 101 through the card interface 325. When the barcode reader 501 is inserted into the slot 115, the digital still camera sets its mode that textual information is inputted by a textual information reading device. The EEPROM 320 stores a control program to control the barcode reader 501. In this mode, the microcomputer 309 in the digital still camera 101 commands, as a host, the microcomputer 502 in the barcode reader 501 to read barcode information.

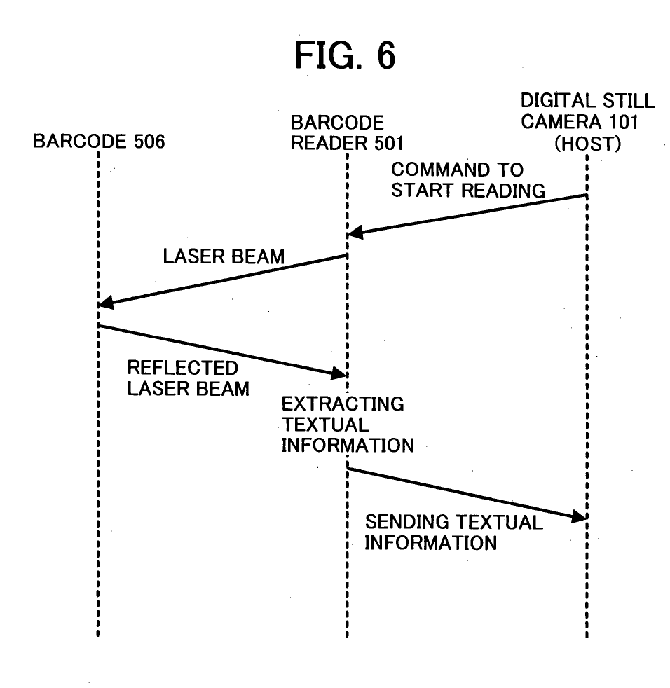

When a user pushes the ENTER button 106 of the operating unit 321 under a condition that the barcode reader 501 is slotted in the slot 501, the digital still camera 101 sends a command of start reading to the barcode reader 501 through the card interface 325, as shown in FIG. 6. Then the barcode reader emits a laser beam to a barcode 506 through a window 507 and receives the laser beam reflected on the barcode 506 at the reflected-laser receiving device 505 through the window 507. The reflected-laser receiving device 505 converts the received laser to electric signals and input the electric signals into the microcomputer 502 in the barcode reader 501. The microcomputer 502 extracts metadata such as textual information from the electric signals on a predetermined procedure. The extracted textual information is sent to the microcomputer 309 in the digital still camera 101 through the card interface 325. The microcomputer 309 adds the textual information to a specified image data. As describe above, the barcode reader 501 is used for reading textual information, instead of the operating unit 321.

In the above explanation, the digital still camera 101 uses the barcode reader 40 for reading metadata such as textual information, but it can also use an OCR (optical character reader) device, which reads a text written or printed by ordinary ink, or a MICR (magnetic ink character recognition) device, which reads a text written or printed by magnetic ink. In these cases, the EEPROM 320 stores a control program to control these devices. Moreover, the reader device of the present invention need not be implemented as a removable card. That is, the reader device may be fixed to the still camera.

There are a lot of demands for adding the photographing location to image data easily such as constructing reinforced concrete building, because there is so many similar structures. Of course, this invention is suitable for not only the case of evidence photography in a construction site, but also many other cases such as photographing products or samples and adding its names or number. In any case, when a user takes many pictures, it tends to be hard to organize the pictures. In such case, it's useful that a user can add textual information to image data easily and quickly as this invention. Additionally, this invention reduces the error in inputting textual information.

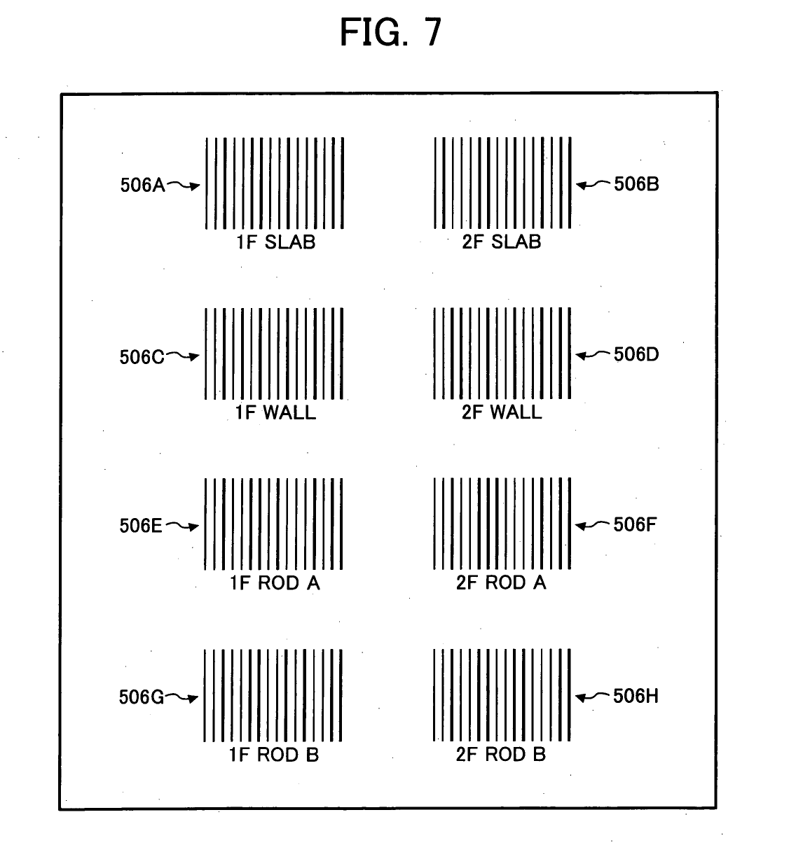

FIG. 7 shows a sheet that a plural of barcodes 506 used in a construction site are printed on, for instance. In FIG. 7, the barcodes 506A to 506H mean 1FSLAB (a slab of the 1^{st} floor), 2FSLAB (a slab of the 2^{nd} floor), 1FWALL (a wall of the 1^{st} floor), 2FWALL (a wall of the 2^{nd} floor), 1FRODA (an “A” rod of the 1^{st} floor), 2FRODA (an “A” rod of the 2^{nd} floor), 1FRODB (an “B” rod of the 1^{st} floor) and 2FRODB (an “B” rod of the 2^{nd} floor) respectively. Using the barcodes of FIG. 7, a user can organize multiple pictures stored in a camera by associating metadata, such as text data, with the pictures.

Finally, the way to add metadata such as textual information to image data in the digital still camera 101 is now explained. A user rotates the switching dial 113 and sets the digital still camera 101 to a playing mode. In the playing mode, a user can choose a picture from pictures stored in the memory card 323. The chosen picture is displayed on the display device 104 and textual information is inputted as described above. Then the textual information is added to the displayed image data and the image data is stored into a memory card again.

There are plural ways to associate metadata such as textual information to image data. One way is superimposing textual information onto the image. Another way is adding textual information on image data, in other words putting textual information into a non-image part of image data file, such as “ImageDescription” field of Exif (exchangeable image file format) file or TIFF (tagged image file format) file. The former method makes it easy to see textual information as a part of the image in an ordinary playing device or software, but a part of the original image may be destroyed and the method may be unable to use added textual information as text data composed of character codes. The latter can add metadata such as a textual image without destroying original image and use text information as text data, but needs a particular device or software to see textual information. Either or both methods can be used for different situations.

Metadata may also be embedded into the image data in accordance with the invention. For example, textual information can be embedded into image data as a digital watermark. The digital watermark may be visible or invisible and can include any type of metadata described above. Moreover, the digital watermark provides a unique way of associating metadata with digital photographs so that the unauthorized copying of the photographs can be traced and/or discouraged. As such, the digital watermark does not need to be read from an external source, but can be read from a memory of a digital still camera such as the memory 322 or 323 of the still camera shown in FIGS. 3A and 3B.

In the above description, textual information is added to an image data restored from the memory card 323 in a playing mode. However, textual information can also be added to an image data stored in main memory 322. Textual information can also be added to an image data just photographed in a photographing mode, or inputted before photographing. After adding textural information, an image data can be stored in the memory card 323, but also can be transmitted to an external device.

Numerous additional modifications and variations are possible in light of the above teachings. It is therefore to be understood that within the scope of the appended claims, the disclosure of this patent specification may be practiced otherwise than as specifically described herein. For example, elements and/or features of different illustrative embodiments may be combined with each other and/or substituted for each other within the scope of this disclosure and appended claims.

The present invention thus also includes a computer-based product which may be hosted on a storage medium and include instructions which can be used to program a microprocessor to perform a process in accordance with the present invention. This storage medium can include any type of storage medium including floppy disks, optical disks, CD-ROMs, magneto-optical disks, ROMs, RAMS, EPROMs, EEPROMs, flash memory, magnetic or optical cards, or any type of media suitable for storing electronic instructions.

This patent specification is based on Japanese patent application, No. JPAP2004-006847 filed on Jan. 14, 2004, in the Japanese Patent Office, the entire contents of which are incorporated by reference herein.

1. An image-recording apparatus comprising:
an image-capturing unit configured to convert an optical image to image data;
a reading device configured to read meta-information from an external source; and
a processing unit configured to control said reading device and to associate the meta-information with the image data.

2. The apparatus according to claim 1, wherein said reading device comprises a barcode reader.

3. The apparatus according to claim 1, wherein said reading device comprises an optical character reader.

4. The apparatus according to claim 1, wherein said reading device comprises a magnetic ink character reader.

5. The apparatus according to claim 1, wherein the processing unit is configured to superimpose the meta-information to the image data.

6. The apparatus according to claim 1, wherein the processing unit is configured to add the meta-information on the image data.

7. The apparatus according to claim 1, wherein the processing unit is configured to embed the meta-information in the image data.

8. The apparatus according to claim 7, wherein the processing unit is configured to embed the meta-information in the image data as a digital watermark.

9. The apparatus according to claim 1, further comprising an image compressing device configured to compress at least one of the image data and meta-information.

10. The apparatus according to claim 1, further comprising a communication interface configured to transmit at least one of the image data and meta-information to an external device.

11. The image-recording apparatus according to claim 1, further comprising:
a memory configured to store the image data;
a memory controller configured to send/read the image data into/from said memory; and
a connection port connecting said reading device to communicate with said processing unit.

12. The apparatus according to claim 11, wherein said memory controller and said connection port are included within the same device.

13. The apparatus according to claim 11, wherein said memory controller and said connection port are discreet devices.

14. The apparatus according to claim 11, wherein said memory controller comprises a CompactFlash compliant memory controller.

15. The apparatus according to claim 11, wherein said communication port comprises a CompactFlash compliant communication port.

16. The apparatus according to claim 11, wherein said memory controller comprises an SD card compliant memory controller.

17. The apparatus according to claim 11, wherein said communication port comprises an SD card compliant communication port.

18. The apparatus according to claim 11, further comprising:
an image compressing device configured to compress the image data, wherein said memory controller is configured to send the compressed image data into said memory.

19. An image-recording apparatus comprising:
means for converting optical image to image data;
means for reading meta-information from an external source; and
means for associating the meta-information with the image data.

20. The apparatus according to claim 19, further comprising means for storing the image data.

21. The apparatus according to claim 19, further comprising means for transmitting the image data to an external device.

22. A method for adding meta-information to image data in an image-recording apparatus, comprising the steps of:
converting an optical image to image data;
reading meta-information from a source external to the image-recording apparatus; and
associating the meta-information with the image data;

23. The method according to claim 22, wherein said converting comprises using a photographing lens to direct said optical image onto an image capturing device.

24. The method according to claim 23, wherein said converting further comprises using a shutter to pass the optical image from the photographing lens to the image capturing device.

25. The method according to claim 22, further comprising a step of storing the image data.

26. The method according to claim 22, further comprising a step of transmitting the image data to an external device.

27. The method according to claim 22, further comprising a step of compressing the image data.

28. The method according to claim 22, wherein said reading step includes reading a barcode.

29. The method according to claim 22, wherein said reading step includes reading a character.

30. The method according to claim 22, wherein reading step includes reading magnetic ink.

31. The method according to claim 22, wherein said associating step includes superimposing the meta-information to the image data.

32. The method according to claim 22, wherein said associating step includes adding the meta-information on the image data.

33. The method according to claim 22, wherein said associating step includes embedding the meta-information in the image data.

34. The method according to claim 33, wherein said associating step includes embedding the meta-information in the image data as a digitized watermark.

35. A computer readable medium storing computer instructions for execution on an image-recording apparatus, which when executed by the image-recording apparatus cause the image-recording apparatus to perform a method for adding meta-information to image data in an image-recording apparatus, the method comprising the steps of:
converting an optical image to image data;
reading meta-information from a source external to the image-recording apparatus; and
associating the meta-information with the image data.

36. The medium according to claim 35, further causing the image-recording apparatus to perform a step of storing the image data.

37. The medium according to claim 35, further causing the image-recording apparatus to perform a step of transmitting the image data to an external device.

38. The medium according to claim 35, further causing the image-recording apparatus to perform a step of compressing the image data.

39. The medium according to claim 35, wherein said reading step includes reading a barcode.

40. The medium according to claim 35, wherein said reading step includes reading a character.

41. The medium according to claim 35, wherein reading step includes reading magnetic ink.

42. The medium according to claim 35, wherein said associating step includes superimposing the meta-information onto the image data.

43. The medium according to claim 35, wherein said associating step includes adding the meta-information on the image data.

44. The medium according to claim 35, wherein said associating step includes embedding the meta-information in the image data.

45. The medium according to claim 44, wherein said embedding includes embedding the meta-information in the image data as a digital watermark.

46. A digital still camera comprising:
a photographing lens for directing an optical image;
an image capturing unit configured to collect an optical image directed from the photographing lens and convert the optical image to image data;
a reading device configured to read meta-information; and
a processing unit configured to control said reading device and to associated the meta-information with the image data as a digital watermark.

47. The digital still camera of claim 46, further comprising a memory configured to store said meta-information, to read said meta-information from said memory.
